(19) United States
(12) Patent Application Publication
(10) Pub. No.: US 2004/0258922 A1
(43) Pub. Date: Dec. 23, 2004

(54) Water-based adhesive compositions with polyamine curative and binder

(76) Inventors: Peggy S. Willett, Stillwater, MN (US); Robert D. Waid, Oakdale, MN (US); Randy S. Frank, London (CA); Tony R. Carrozzella, London (CA)

Correspondence Address: 3M INNOVATIVE PROPERTIES COMPANY, PO BOX 33427, ST. PAUL, MN, 55133-3427, US

(21) Appl. No.: 10/600,681

(22) Filed: Jun. 20, 2003

(51) Int. Cl. B32B 27/38; B32B 15/08; C08L 63/00

(52) U.S. Cl. 428/418; 428/413; 525/902; 523/201; 523/400

(57) ABSTRACT

Water-based adhesive compositions are described that includes epoxy capsules and a polymeric amine that is water soluble or water dispersible. The epoxy capsules include an outer shell material and an epoxy resin encapsulated by the outer shell material. The polymeric amine functions as an epoxy curative and as a binder resin. The compositions are substantially free of other additional organic binders. The compositions are suitable for use as mechanical fastener adhesives.

### FIELD OF THE INVENTION

The invention relates to water-based adhesives and to articles that include the water-based adhesives. The invention also relates to methods of making the water based adhesives and to methods of making articles such as mechanical fasteners that include the water-based adhesives.

### BACKGROUND OF THE INVENTION

For over thirty years, adhesives have been used to coat mechanical fasteners (i.e., screws, bolts, nuts, pipe joints, threaded nails, etc.) that are attached to an object. The term “fastener adhesives” has been used to describe such adhesive compositions. The fastener adhesive is used, for example, to prevent bolt and nut assemblies from loosening due to application of stress, vibration, or exposure to various chemicals.

Typically, fastener adhesives contain a microencapsulated epoxy resin, an amine curative, and an organic binder. The fastener adhesives can be used to coat at least a portion of the mechanical fastener, such as the threads of a bolt or screw. In these adhesive systems, the epoxy resin is separated from the amine curative (e.g., by encapsulating the epoxy resin) to prevent premature curing of the adhesive composition prior to use. During the process of attaching the coated mechanical fastener (e.g., screwing a screw or bolt into a desired object), the microcapsules are crushed, causing the epoxy resin and the amine curative to mix, resulting in an activated adhesive. The activated adhesive composition typically cures over a period of several days. However, heating can accelerate the rate of cure.

### SUMMARY OF THE INVENTION

One aspect of the invention is directed to a water-based adhesive composition that contains epoxy capsules and a polymeric amine that is water soluble or water dispersible The epoxy capsules include an outer shell material and encapsulated material surrounded by the outer shell material. The encapsulated material includes epoxy resin. The polymeric amine functions as an epoxy curative (i.e., bond forming material with the epoxy resin) and as a binder resin (i.e., a film forms when the polymeric amine is combined with epoxy capsules and the solvent or water is removed). The adhesive compositions are substantially free of other additional organic binder resins. The water-based adhesive composition of the present invention can be used in a variety of applications including, but not limited to, fastener or thread-locking adhesives (e.g., adhesive coatings for mechanical fasteners).

The present invention is also directed to articles of manufacture that include a substrate such as a mechanical fastener having a water-based adhesive coated thereon. The water-based adhesive includes epoxy capsules and a polymeric amine that functions both as an amine curative and as a binder resin. The epoxy capsules include an outer shell material and an epoxy resin encapsulated by the outer shell material. The adhesive compositions are substantially free of other additional organic binder resins. The articles often exhibit improved humidity resistance. That is, articles such as mechanical fasteners that are coated with the water-based adhesive compositions often can be stored for a period of up to one year without negatively impacting the adhesive coating thereon.

Yet another aspect of the invention is directed to a method of making the water-based adhesive composition. Microencapsulated epoxy resin in the form of epoxy capsules are mixed with a polymeric amine that is water soluble or water dispersible. The invention also provides a method of making articles such as mechanical fasteners that are coated with the water-based adhesive compositions.

The above summary of the present invention is not intended to describe each disclosed embodiment or every implementation of the present invention. The Figures and the detailed description that follow more particularly exemplify these embodiments.

### BRIEF DESCRIPTION OF THE DRAWINGS

The above aspects may be more completely understood in consideration of the following detailed description of various embodiments in connection with the accompanying drawings, in which:

FIG. 1 is a cross-sectional view of a coated mechanical fastener;

FIG. 2 is a photograph of exemplary epoxy capsules viewed using a Scanning Electron Microscopy at 150× magnification; and

FIG. 3 is a graphical display of an exemplary particle size distribution for a sample of suitable epoxy capsules.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the present disclosure.

### DETAILED DESCRIPTION OF THE INVENTION

The present invention is directed to a water-based adhesive composition. The invention is also directed to articles that include the water-based adhesive composition. Exemplary articles include, but are not limited to, mechanical fasteners such as screws, bolts, nuts, pipe joints, threaded nails, and the like.

Industrial and automotive equipment manufacturers rely on fastener adhesives to prevent critical parts from failing. The adhesive is typically applied to a mechanical fastener such as a bolt, nut, screw, pipe joint, or nail prior to assembly. It is not unusual for fasteners to be coated with the adhesive and then stored for months before use. In some instances, the adhesive coated fasteners are stored in hot and humid climates. The adhesive composition is desirably humidity resistant (i.e., resistant to loss of strength after exposure to a high humidity environment as determined using the Humidity Stability Test).

Solvent based fastener adhesives are available that include a microencapsulated epoxy resin, an amine curative, and a poly(vinylbutyral) binder resin. However, at least some of these fastener adhesives loose strength when exposed to a humid environment. Water based fastener adhesives are also available. For example, one such adhesive composition includes microencapsulated epoxy resin, an amine, and a water soluble polyvinylacetal resin. At least some of these water based fastener adhesives are not humidity resistant.

Articles such as mechanical fasteners that are coated with the water-based adhesive compositions of the invention can typically be stored for extended periods (e.g., months) prior to assembly. The adhesive coated articles can be stored in climates with elevated temperature and humidity without adversely affecting the performance characteristics of the adhesive.

The adhesive compositions of the invention are water-based. As used herein, “water-based” refers to a composition that is substantially free of organic solvents. For example, the adhesive compositions contain no more than about 5 wt-%, no more than about 3 wt-%, no more than about 2 wt-%, no more than about 1 wt-%, or no more than about 0.5 wt-% organic solvent based on the weight to the adhesive composition. In some embodiments, there is no organic solvent present. Water-based adhesives can be environmentally advantageous compared to solvent based adhesives. For example, solvent emissions can be reduced. Further, the water-based compositions can reduce exposure of workers to hazardous, flammable solvents.

The water-based adhesive composition includes a microencapsulated epoxy resin and a polymeric amine that is water soluble or water dispersible. The polymeric amine functions as both an amine curative and binder resin. The composition is typically substantially free of other additional binder resins.

The polymeric amine can be water soluble or water dispersible. As used herein, the term “water soluble” refers to a material that can be dissolved in water. The solubility is typically at least about 0.1 gram per mole of water. As used herein, the term “water dispersible” refers to a material that is not water soluble but that can be emulsified or suspended in water. The polymeric amine functions as both an epoxy curative and a binder resin. As used herein, the term “epoxy curative” refers to a compound that can cure an epoxy resin. The polymeric amine reacts with the epoxy resin to form a copolymer. As used herein, the term “binder resin” refers to a compound that can form a film when it is combined with epoxy capsules and the water or solvent is removed.

The water-based adhesive compositions of the present invention can be used in applications where humidity resistance is a consideration, such as an application where the adhesive is exposed to the environment and stored for days or months prior to use. The adhesives typically do not loose strength when stored in climates with elevated temperatures and humidity.

The present invention is also directed to various articles of manufacture that include a substrate coated with the water-based adhesive compositions. In particular, the present invention is directed to mechanical fasteners that are coated with the water-based adhesive composition.

### Water-Based Adhesive Composition

The following materials can be used to form the water-based adhesive compositions of the present invention: epoxy capsules, polymeric amine, and optional materials such as cross-linking agents, fillers, thickeners, and additives. The adhesives can be a one-part or a two-part composition. As used herein, the term “one-part” refers to an adhesive composition where the epoxy capsules are mixed with the polymeric amine prior to use. As used herein, the term “two-part” refers to an adhesive composition where the epoxy capsules are stored in a separate container from the polymeric amine prior to use; the epoxy capsules and polymeric amine are mixed at the time of use.

A. Epoxy Capsules

The water-based adhesive composition includes one or more microencapsulated epoxy resins (herein referred to as “epoxy capsules”). Epoxy capsules have an outer shell material (i.e., the encapsulating material) and one or more epoxy resins (i.e., the encapsulated material). The outer shell material encapsulates the epoxy resins. That is, the encapsulated materials are in the core of the epoxy capsules and are surrounded by the outer shell material.

A variety of encapsulating materials can be used to form the outer shell of the epoxy capsules. Suitable encapsulating materials include, but are not limited to, cross-linked resin materials or polymers formed by reacting formaldehyde with at least one materials selected from urea, melamine, or a combination thereof. In some applications, the encapsulating material is a urea-formaldehyde-melamine material. The urea-formaldehyde-melamine material can include up to about 50 weight percent (wt-%) urea, up to about 70 wt-% formaldehyde, and up to about 30 wt-% melamine based on the total weight of the encapsulating material. The encapsulating material often includes about 20 to about 50 wt-% urea, about 30 to about 70 wt-% formaldehyde, and about 3 to about 30 wt-% melamine. For example, the encapsulating material can include about 35 to about 50 wt-% or about 40 to about 50 wt-% urea, about 40 to about 60 wt-% or about 45 to about 55 wt-% formaldehyde, and about 5 to about 15 wt-% or about 5 to about 10 wt-% melamine. In a more specific example, the encapsulating material can include a urea-formaldehyde-melamine material containing about 42 to about 46 wt-% urea, about 46 to about 50 wt-% formaldehyde, and about 6 to about 10 wt. % melamine.

Formation of the encapsulating material and the epoxy capsules can be carried out using any microencapsulation technique known in the art. One suitable method is described in Example 1 below.

The encapsulated material includes an epoxy resin. Epoxy resins suitable for use in the epoxy capsules as the encapsulated material may be any organic compound having at least one oxirane ring that is polymerizable by a ring opening reaction. These materials generally have, on average, at least two oxirane rings per molecule and may also be referred to as “polyepoxides” or “epoxides.” The “average” number of epoxy groups per molecule is defined as the number of epoxy groups in the epoxy resin divided by the total number of epoxy molecules present. Such materials include both monomeric and polymeric epoxides and may be, for example, aliphatic, alicyclic, heterocyclic, cycloaliphatic, or aromatic and may further be combinations thereof. Epoxides may be liquid or solid or blends thereof, blends being especially useful in providing tacky adhesive films. The polymeric epoxides include, but are not limited to, linear polymers having terminal epoxy groups (for example, a diglycidyl ether of a polyoxyalkylene glycol), polymers having skeletal oxirane units (for example, polybutadiene polyepoxide), and polymers having pendent epoxy groups (for example, a glycidyl methacrylate polymer or copolymer). The molecular weight of the epoxy resin may vary from about 74 to about 100,000 or more. Mixtures of various epoxy resins may also be used in the adhesive compositions of the present invention.

Suitable epoxy resins for use in the present invention include, but are not limited to, epoxy resins that contain cyclohexene oxide groups such as the epoxycyclohexane carboxylates, typified by 3,4-epoxycyclohexylmethyl-3,4-epoxycyclohexane carboxylate, 3,4-epoxy-2-methylcyclohexylmethyl-3,4-epoxy-2-methylcyclohexane carboxylate, and bis(3,4-epoxy-6-methylcyclohexylmethyl) adipate. For a more detailed list of useful epoxides of this nature, reference may be made to U.S. Pat. No. 3,117,099, the disclosure of which is incorporated herein by reference.

Other epoxy resins suitable for use in the present invention, include glycidyl ether monomers and have a structure as shown below:

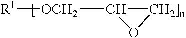

where R¹ is aliphatic (e.g., an alkyl group), aromatic (e.g., an aryl group), or a combination thereof; and n is an integer from about 1 to about 6. Examples of epoxy resins having a structure as shown above include, but are not limited to, glycidyl ethers of polyhydric phenols obtained by reacting a polyhydric phenol with an excess of chlorohydrin such as epichlorohydrin. For example, the epoxide can be a diglycidyl ether of 2,2-bis-(4-hydroxyphenol)propane (Bisphenol A). Further examples of epoxides of this type are described in U.S. Pat. Nos. 3,642,937 and 3,746,068, both of which are assigned to 3M Company (St. Paul, Minn.), the disclosures of which are incorporated herein by reference.

A number of commercially available epoxy resins can be used. Epoxides that are readily available include, but are not limited to, octadecylene oxide; epichlorohydrin; styrene oxide; vinylcyclohexene oxide; glycidol; glycidyl methacrylate; diglycidyl ether of Bisphenol A containing materials (for example, those available under the trade designations “EPON™ 815C”, “EPON™ 813”, “EPON™ 828”, “EPON™ 1004”, and “EPON™ 1001F” from Resolution Performance Products, Houston, Tex.); diglycidyl ether of bisphenol F (for example, those available under the trade designations “ARALDITE™ GY281” from Ciba Specialty Chemicals Holding Company, Basel, Switzerland, and “EPON™ 862” from Resolution Performance Products); vinylcyclohexane dioxide (for example, one available under the trade designation “ERL-4206” from Dow Chemical Co., Midland, Mich.); 3,4-epoxycyclohexylmethyl-3,4-epoxycyclohexene carboxylate (for example, one available under the trade designation “ERL-4221” from Dow Chemical Co.); 2-(3,4-epoxycyclohexyl-5,5-spiro-3,4-epoxy) cyclohexane-metadioxane (for example, one available under the trade designation “ERL-4234” from Dow Chemical Co.); bis(3,4-epoxycyclohexyl) adipate (for example, one available under the trade designation “ERL-4299” from Dow Chemical Co.); dipentene dioxide (for example, one available under the trade designation “ERL-4269” from Dow Chemical Co.); epoxidized polybutadiene (for example, one available under the trade designation “OXIRON™ 2001” from FMC Corp., Chicago, Ill.); epoxy silanes (for example, beta-3,4-epoxycyclohexylethyltrimethoxy silane and gamma-glycidoxypropyltrimethoxy silane, commercially available from Dow Chemical); flame retardant epoxy resins (for example, one available under the trade designation “DER-542”, a brominated bisphenol type epoxy resin available from Dow Chemical Co.); 1,4-butanediol diglycidyl ether (for example, one available under the trade designation “ARALDITE™ RD-2” from Ciba Specialty Chemicals); hydrogenated bisphenol A-epichlorohydrin based epoxy resins (for example, one available under the trade designation “EPONEX™ 1510” from Resolution Performance Products); and polyglycidyl ether of phenol-formaldehyde novolak (for example, one available under the trade designation “DEN-431” and “DEN-438” from Dow Chemical Co.).

The encapsulated material can include epoxy resin mixed with an optional epoxy diluent. The epoxy diluent is often added to lower the viscosity of the epoxy resin. The epoxy diluent is selected to be compatible with the epoxy resin and typically has low solubility in the water phase. The epoxy diluent typically contains one epoxy group per molecule. Suitable materials include, for example, n-butyl glycidyl ether, o-cresyl glycidyl ether, and materials similar to those found in the HELOXY™ Epoxy Resin Modifiers product family (Resolution Performance Products).

In one specific application, the encapsulated material is EPON 815C™, a mixture of Bisphenol A diglycidyl ether and n-butyl glycidyl ether. In yet another specific application, the encapsulated material is EPON 813™, a mixture of Bisphenol A diglycidyl ether and o-cresyl glycidyl ether.

The epoxy capsules can contain other encapsulated materials in addition to the epoxy resin. Suitable additional encapsulated materials include, but are not limited to, solvents or plasticizers. Addition of these materials to the epoxy resin can be used, for example, to lower the viscosity to the appropriate range for the microencapsulation process.

Suitable epoxy capsules typically include, for example, about 70 to about 95 wt-% encapsulated material and about 5 to about 30 wt-% encapsulating material based on the weight of the epoxy capsules. In some embodiments, the epoxy capsules include about 75 to about 90 wt-% or about 80 to about 90 wt-% of the encapsulated material and about 10 to about 25 wt-% or about 10 to about 20 wt-% encapsulating material.

The water-based adhesive composition can include from about 20 to about 60 wt-% epoxy capsules, from about 30 to about 50 wt-% epoxy capsules, or from about 35 to about 40 wt-% epoxy capsules based on the total weight of the adhesive composition.

Exemplary epoxy capsules are shown in FIG. 2. The epoxy capsules shown in FIG. 2 were photographed using a Scanning Electron Microscopy at 150× magnification. As shown in FIG. 2, the epoxy capsules can be present as a single capsule 21, as a cluster of capsules 22, or as a combination thereof.

The size and shape of the epoxy capsules can vary depending on the desired use of the water-based adhesive composition. In general, the encapsulation process produces capsules having a size distribution (i.e., there are a range of capsule sizes). The size distribution can be measured by Laser Light Scattering and is typically a normal, or almost normal, distribution of the epoxy capsule diameters. One way to describe the capsule size distribution is by a median (i.e., middle value of the distribution) particle size. The capsules often have a spherical shape and a median particle diameter up to about 40 micrometers, up to about 60 micrometers, up to about 80 micrometers, up to about 100 micrometers, or up to about 120 micrometers. For example, the capsules can have a spherical shape and a median particle diameter ranging from about 20 to about 120 micrometers, from about 25 to about 100 micrometers, or from about 30 to about 70 micrometers.

The epoxy capsules can be characterized by their particle size distribution. Ninety percent of the capsules typically have a diameter greater than about 10 micrometers. In some embodiments, ninety percent of the capsules have a diameter greater than about 15 micrometers, greater than about 20 micrometers, greater than about 30 micrometers, greater than about 40 micrometers, greater than about 50 micrometers, or greater than about 60 micrometers. Ninety percent of the capsules typically have a diameter no more than about 220 micrometers. In some embodiments, ninety percent of the capsules have a diameter no more than about 200 micrometers, no more than about 160 micrometers, no more than about 140 micrometers, no more than about 120 micrometers, no more than about 100 micrometers, or no more than about 80 micrometers.

In some exemplary epoxy capsules, at least 80 percent of the capsules are in the size range of about 15 to about 80 micrometers with a median diameter of about 30 to about 40 micrometers. In other exemplary epoxy capsules, at least about 80 percent of the capsules are in the size range of about 15 to about 140 micrometers with a median diameter of about 50 to about 60 micrometers.

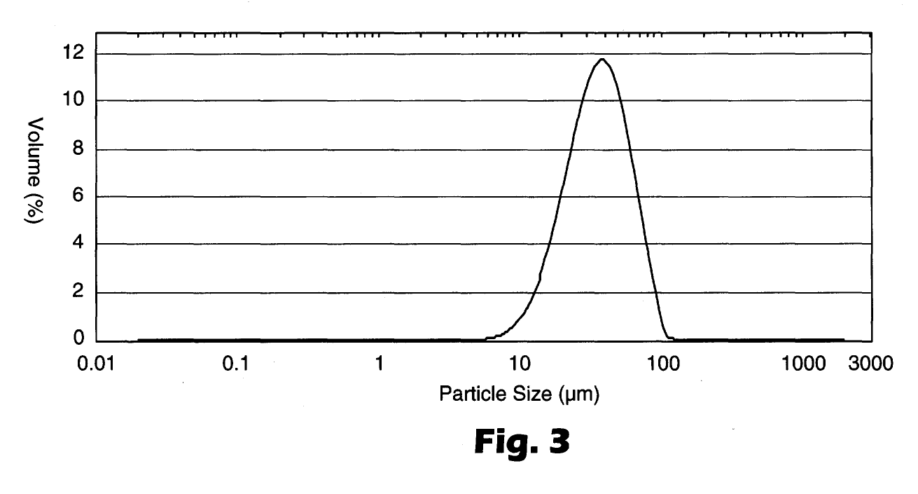

One exemplary particle size distribution for a sample of epoxy capsules suitable for use in present invention is shown in FIG. 3. A median diameter of 36 micrometers is shown at peak 31 in FIG. 3.

B. Polymeric Amines

The water-based adhesive compositions contain one or more polymeric amines that are water-soluble or water-dispersible. The polymeric amines are film-forming materials and non-volatile. The polymeric amines are also curatives for the epoxy resins. That is, the polymeric amines react with the epoxy resins to form a copolymeric material.

Suitable polymeric amines include, but are not limited to, polyamidoamines such as ANQUAMINE™ 360, 401, 419, 456, and 701 (Air Products and Chemicals, Allentown, Pa.); LUPASOL™ polyethylenimine polymers such as FG, PR 8515, Waterfree, P, PS (BASF Corporation, Resselaer, N.Y.); polyethylenimine polymers such as CORCAT™ P-600 (EIT Company, Lake Wylie, S.C.); polyoxyalkyleneamines such as JEFFAMINE™ D-230, D-400, D-2000, HK-511 (XTJ-511), XTJ-510 (D-4000), XTJ-500 (ED-600), XTJ-502 (ED-2003), T-403, XTJ-509 (T-3000), and T-5000 (Huntsman Corporation, Houston, Tex.); and polyamide resins such as the VERSAMID series of resins that are formed by reacting a dimerized unsaturated fatty acid with alkylene diamines (Cognis Corporation, Cincinnati, Ohio).

The water-based adhesive composition includes one or more polymeric amines in an amount that depends on the particular polymeric amine, the desired adhesive properties, and the use of the particular adhesive. The water-based adhesive composition typically includes up to about 70 wt-%, up to about 60 wt-%, up to about 50 wt-%, up to about 40 wt-%, up to about 30 wt-%, or up to about 20 wt-% polymeric amine based on the total wet weight of the adhesive composition. For example, the adhesive composition can include about 10 to about 60 wt-%, about 15 to about 50 wt-%, or about 20 to about 40 wt-% of one or more polymeric amines.

C. Optional Additional Organic Binder Material

The polymeric amine curative functions as both an epoxy curative and as a binder resin. The adhesive compositions can be substantially free of other additional binder material. When referring to any additional organic binder material or resin, the term “substantially free” means that the compositions contains no more than 0.1 wt-% of additional organic binder material. In some embodiments, the adhesive compositions contain no more than about 0.07 wt-%, no more than about 0.05 wt-%, or no more than about 0.03 wt-%, no more than about 0.01 wt-%, or no additional organic binder material. The additional organic binder material can be present as an impurity in another component of the adhesive composition. This additional organic binder material can be water soluble, water insoluble, or a combination thereof.

If the additional organic binder material is water insoluble, the binder may be a water-based polymer dispersion (e.g., a latex, emulsion, colloidal suspension, or the like). Such binder resins include, but are not limited to, ethylene-vinyl acetate (EVA) copolymer emulsions, ethylene-vinyl chloride copolymer emulsions, vinyl acetate-ethylene-vinyl chloride copolymer emulsions, acrylate-vinyl acetate-ethylene copolymer emulsions, vinyl acrylic emulsions, acrylic emulsions, vinyl acetate-acrylic copolymer emulsions, styrene-acrylic copolymer emulsions, vinyl chloride-vinyl acetate-ethylene terpolymer emulsions, vinyl acetate homopolymer emulsions, polyester dispersions, polyurethane dispersions, acrylic-urethane dispersions, butadiene dispersions, and butadiene-styrene copolymer dispersions.

If the additional water soluble binder material is water insoluble, the binder may include polyacetal binder resins such as those described in U.S. Pat. No. 5,283,266, incorporated herein by reference, or any other material known in the art.

D. Optional Cross-Linking Agents

The water-based adhesive compositions can also contain one or more optional cross-linking agents to enhance the tensile strength or chemical resistance of the adhesive coating. Suitable cross-linking agents are those that are compatible with the adhesive component, particularly the epoxy capsules and polymeric amines. Cross-linking agents include, but are not limited to, water-based zinc oxide dispersions such as OCTOCURE 462, and combinations of zinc compound and sulfur compound dispersions such as OCTOCURE 590 and T2000. These materials are known as rubber accelerators, vulcanizates and stabilizers. In some applications, the cross-linking agent can improve coating properties by cross-linking thermoplastic binder resins that may be present.

OCTOCURE 462 is an aqueous dispersion of zinc oxide having a surface area of 8 to 10 m²/g. OCTOCURE 462 has the following physical properties: solids content of about 60 to 62%; a pH of about 9 to 11; a viscosity of about 1000 to 3000 cps; and an average particle size of no more than about 5 micrometers.

OCTOCURE 590 is a composite mixture of ingredients that can accelerate vulcanization of latex compounds. This composite mixture contains curatives, accelerators, antioxidants, and colloidal stabilizers in the following ratio of active parts: zinc oxide—2.00 parts; sulfur—1.65 parts; ZMBT (zinc mercaptobenzothiazole)—0.50 parts; ZDE (zinc diethyldithiocarbamate)—1.00 parts; and an antioxidant—0.75 parts. OCTOCURE 590 has the following physical properties: solids content of about 59 to 61%; a pH of about 9 to 10; a viscosity of about 1000 to 3000 cps; and an average particle size of no more than about 10 micrometers.

Another class of cross-linking agents is the polyfunctional aziridines described in U.S. Pat. No. 5,783,303, the disclosure of which is hereby incorporated by reference. Suitable, commercially available polyfunctional aziridines are available under the trade designations “XAMA-2” and “XAMA-7” (B. F. Goodrich Chemical Co., Cleveland, Ohio), and “CROSSLINKER CX-100” (Neoresins, a business unit of Avecia, Wilmington, Mass.).

Another method of cross-linking the adhesive composition is by addition of a small amount of water-dispersed epoxy resin to the adhesive composition, such that the polymeric amine is present in excess of the water-dispersed epoxy resin. The water-dispersed epoxy resin can react with a small amount of the polymeric amine and thereby improve the physical properties of the adhesive coating. It is typically desirable that the polymeric amine is not used up in the reaction with the water-dispersed epoxy resin so that the excess can react with the epoxy in the capsules when the capsules are broken open. Addition of the water-dispersed epoxy resin is particularly useful if the adhesive is delivered in a two-part format, where the polymeric amine is separate from the epoxy capsules. The water dispersed epoxy resin can be added to the adhesive component containing the epoxy capsules and is not reacted until mixed with the polymeric amine. Examples of commercially available water-dispersed epoxy resins include, but are not limited to, ANCAREZ™ AR550 (Air Products, Inc., Philadelphia, Pa.); and EPI-REZ™ Resins 3515-W-60, 3515-W-50, 3519-W-50, and 3522-W-60 (Resolution Performance Products, Houston, Tex.).

The water-based adhesive composition can contain up to about 5 wt-% of one or more of the above-described cross-linking agents. For example, the adhesive composition can contain about 0.05 wt-% to about 5 wt-% of one or more cross-linking agents. In some embodiments, the adhesive composition can contain about 0.5 to 3.0 wt-% of one more cross-linking agents.

E. Water

The water-based adhesive compositions typically include water as a dispersing agent and viscosity modifier. The compositions typically contain about 10 wt-% to about 80 wt-% water. For example, the water-based adhesive composition can contain about 10 wt-% to about 60 wt-% water, about 10 wt-% to about 50 wt-%, about 10 wt-% to about 40 wt-% about or about 10 wt-% to about 30 wt-% water, or about 10 wt-% to about 20 wt-% based on a total weight of the adhesive composition.

F. Optional Fillers

The water-based adhesive compositions can also contain one or more optional inorganic filler materials or polymeric filler materials.

Suitable inorganic filler materials are described in Organic Coatings: Science and Technology, Wicks et al., John Wiley & Sons, (1972) p. 318-321. These fillers can include, but are not limited to, titanium dioxide, calcium carbonate, mica (aluminum potassium silicate), kaolin clays, talc (magnesium silicate), silicon dioxide, diatomaceous (Fuller's) earth, iron oxide, Wollastonite, zeospheres, zinc chromate, zinc phosphate, zinc oxide, barium sulfate, or combinations thereof. In some embodiments, the filler material includes titanium dioxide, mica, and calcium carbonate. In other embodiments, the filler material includes a mixture of titanium dioxide and mica.

Suitable polymeric filler materials include, for example, polyethylene, polytetrafluoroethylene, and the like. The polymeric filler material can be a powder, a fiber, or a combination thereof.

The adhesive composition can contain up to about 30 wt-% of one or more of the above-described inorganic or polymeric filler materials based on a total weight of the adhesive composition. In some embodiments, the water-based adhesive composition contains up to about 20 wt-% or up to about 10 wt-% of filler material. For example, the compositions can include about 15 wt-% to about 20 wt-% of any of the above-described inorganic or polymeric filler materials based on a total weight of the adhesive composition.

G. Optional Thickeners

One or more optional thickeners can be used in the water-based adhesive compositions to increase the viscosity of the dispersions. In some applications, it can be advantageous to increase the viscosity of the liquid adhesive such that the epoxy capsules and fillers stay suspended and do not settle to the bottom of a container. Thickeners also can improve the adhesive coating properties by providing coatings that do not sag. Suitable thickeners are those that are compatible with the adhesive components. As used herein, “compatible” means that the thickener does not cause adverse affects to the curable composition (e.g., precipitation, flocculation, or other separation of the components), or to the cured coating (e.g., disruption of film continuity, phase separation, or loss of adhesion to the backing).

Typical organic thickeners for use in the water-based adhesive compositions of the present invention are associative thickeners. As used herein, “associative thickener” refers to a polymeric compound having hydrophobic groups that associate with each other or the dispersed polymer particles of the curable coating composition. Examples of thickeners are the non-ionic polyurethanes ACRYSOL™ RM-825, RM-8W, RM-1020, RM-2020NPR, RM-12W and SCT-275 (Rohm & Haas, Philadelphia Pa.). An associative thickener, or mixture of associative thickeners, can be present in the adhesive compositions in an amount effective to increase the viscosity of the adhesive such that the epoxy capsules and filler stay suspended and to provide coatings that do not sag. Typically, an associative thickener, or mixture of associative thickeners, is present in the adhesive compositions in an amount no more than about 1 wt-%. For example, the associative thickener can be present in an amount of about 0.05-0.8 wt-%, based on the total weight of the adhesive composition.

Inorganic thickeners for use in the adhesive compositions of the present invention include, but are not limited to, metallic oxides, such as aluminum oxide silicon dioxide, and attapulgite clays. In some embodiments, the inorganic thickeners are aluminum oxide and attapulgite clay. For example, aluminum oxide can be present in the A-side (i.e., amine side) of a two part adhesive compositions in an amount no more than about 1 wt-% (e.g., in an amount of about 0.05-0.8 wt-%) based on the total weight of the adhesive composition. In other embodiments, attapulgite clay thickener can be present in the B-side (i.e., epoxy side) of a two part adhesive compositions in an amount no more than about 0.5 wt-% (e.g., in an amount of about 0.05-0.3 wt-%) based on the total weight of the adhesive composition.

H. Other Additives

The adhesive composition can contain up to about 50 wt-%, up to about 35 wt-%, up to about 25 wt-%, up to about 10 wt-%, or up to about 5 wt-% of various optional additives such as stabilizers, antioxidants, plasticizers, surfactants, defoamers, tackifiers, flow control agents, cure rate retarders, adhesion promoters (for example, silanes and titanates), adjuvants, flattening agents, UV absorbers, UV scavengers, impact modifiers, expandable microspheres, thermally conductive particles, electrically conductive particles, pigments, colorants, glass beads or bubbles, and the like that are compatible with water-based systems. Any of these components, as well as any of the components listed above, can be used in various combinations, including two or more of each type of compound, to achieve desired results.

### Methods of Making Adhesive Compositions

The water-based adhesive compositions can be prepared by mixing the adhesive composition components using conventional methods, as is well known by one skilled in the art. The components can be added simultaneously or sequentially; normally, low shear mixing equipment can be used. The components can be added in any order when making an adhesive composition.

In one exemplary method of making a one part system, the following components are mixed: the epoxy capsules, water, the polymeric amine, and any optional materials such as fillers, thickeners, cross-linking agents, additives, and the like. In one exemplary method of making a two part adhesive (parts A and B), the components of part A (i.e., amine-side) can include the following: polymeric amine, water, and optional additives, cross-linking agents, thickeners, and fillers. The components of part B (i.e., epoxy-side) can include the following: epoxy capsules, water, and optional additives, cross-linking agents, thickeners, and fillers.

The adhesive compositions can be prepared as either one or two part adhesives. The one or two part adhesive compositions may be used directly after mixing or may be stored in suitable containers for future use. In compounding, or in customer use, additional water may be added to adjust the viscosity of the adhesive composition as desired.

The epoxy capsules used in the adhesive compositions can be made by any known microencapsulation technique. One desired method of preparing the epoxy capsules of the present invention can be found in Example 1 below. Other microencapsulation techniques well known to those skilled in the art are disclosed in U.S. Pat. Nos. 3,179,143; 3,642,937; and 3,746,068; Microcapsule Processing and Technology by Kondo (Marcel Dekker, 1979); and Microencapsulation (Encyclopedia of Polymer Science and Engineering, 2^{nd} edition, Vol. 9, p. 724), the disclosures of which are hereby incorporated by reference.

### Articles of Manufacture

The water-based adhesive compositions can be applied to a wide variety of substrates by any methods known in the art. Suitable methods of application include, but are not limited to, spraying, gravure printing, dip coating (e.g., dipping the substrate into the adhesive composition), or flow coating (e.g., flowing the adhesive composition over the substrate). Substrates that can be coated with the adhesive compositions include, but are not limited to, plastics, metals, ceramics, glass and cellulosic materials. Substrates can be in any configuration including, but not limited to, three-dimensional complex shapes, films, foils, foams, fabrics, tubes or pipes, etc. The adhesive compositions of the present invention are particularly useful as adhesive coatings on primed, bare, or painted metal substrates such as stainless steel, aluminum, cold rolled steel, and porcelainized steel. Moreover, the adhesive compositions of the present invention are particularly useful as adhesive coatings on mechanical fasteners such as bolts, nuts, screws, pipe joint, and nails.

The amount of adhesive coating can vary depending on a number of factors including, but not limited to, the adhesive composition, the coating method, the substrate, and the particular application or use. Typically, a continuous adhesive coating is applied to at least a portion of a given substrate such that the coated areas have a basis coating weight of up to about 50 grams per square meter (gsm). When the adhesive is applied to a mechanical fastener such as a screw, a nut, bolt, pipe joint, or nail, the coating weight typically ranges from 0.05 grams to 0.50 grams, depending on the size of the fastener and how many of the threads are coated, with higher coating weights used on larger sized fasteners. However, the amount of adhesive coating is not limited in any way.

### Specific Uses

In one aspect of the present invention, the above-described water-based adhesive composition is coated onto at least a portion of a mechanical fastener. Suitable mechanical fasteners include, but are not limited to, screws, bolts, nuts, nails, etc. As the mechanical fastener is attached to a given object, the force exerted on the mechanical fastener causes the epoxy capsules to rupture. The epoxy resin and the polymeric amine intermix, initiating the curing process for the epoxy resin. The resulting mechanical fastener is mechanically, as well as, adhesively bonded to the object via the adhesive composition.

In one embodiment, the mechanical fastener includes a bolt and nut assembly, wherein the threads of the bolt are coated with the above-described adhesive composition. The threads of the nut can also be coated with the adhesive composition. The resulting bolt and nut assembly has suitable humidity resistance prior to use, as well as, suitable bonding strength when attached to one another.

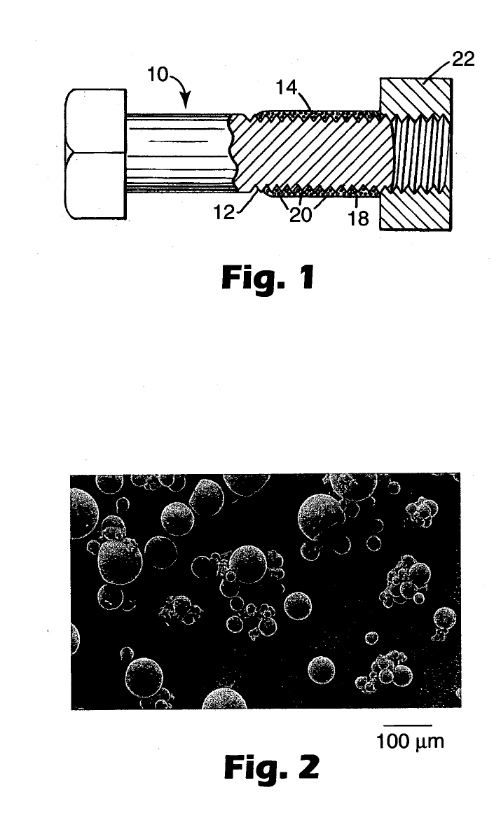

An exemplary coated mechanical fasteners is shown in FIG. 1. Bolt 10 is coated with an adhesive composition 14, which coats at least a portion of threads 12. Adhesive composition 14 desirably includes a polymeric amine 18 having distributed therein epoxy capsules 20 (shown greatly enlarged), which contain a curable resin. As nut 22, or equivalent mating threaded device, is threaded onto bolt 10, some of the epoxy capsules 20 are ruptured by the shearing forces produced. The shearing forces caused by threading nut 22 onto bolt 10 also result in thorough mixing of the epoxy resin released from the epoxy capsules 20 with the polymeric amine curing agent, thus promoting cure of the released resin.

One method of measuring the humidity resistance of an adhesive composition on a mechanical fastener, such as a bolt and nut assembly, is to subject the coated mechanical fastener to humid conditions for a period of time, attach the mechanical fastener to an object, let the adhesive cure, and then measure the adhesive bonding strength between the mechanical fastener and the object. The degree of humidity resistance of a given adhesive composition can be determined based of a minimum level of adhesive bonding strength and/or a percent retention of adhesive bonding strength relative to an original amount of adhesive bonding strength (i.e., the adhesive bonding strength of an adhesive composition that has not been subjected to the humid conditions). One such test is the “Humidity Stability Test” described below.

Typically, the water-based adhesive compositions have a breakaway torque value (as measured by the “Breakaway Torque Test” described below) after being subjected to the Humidity Stability Test described below of at least about 5 N-m. In some embodiments, the adhesive compositions of the present invention have a breakaway torque value after being subjected to the Humidity Stability Test of at least about 10 N-m, at least about 15 N-m, or at least about 20 N-m.

The present invention is described above and further illustrated below by way of examples, which are not to be construed in any way as imposing limitations upon the scope of the invention. On the contrary, it is to be clearly understood that resort can be had to various other embodiments, modifications, and equivalents thereof which, after reading the description herein, can suggest themselves to those skilled in the art without departing from the spirit of the present invention and/or the scope of the appended claims.

### TEST EQUIPMENT

The following test equipment was used in the Test Methods and Examples described below.

Nuts and Bolts

Zinc-plated nuts and bolts (size ⅜ inch) were purchased from Adams Nut and Bolt, Maple Grove, Minn., USA. The nuts and bolts were cleaned by immersing each nut or bolt in toluene for 10 minutes, draining and air-drying.

Torque Wrench

A “follow-up” torque wrench with dial readout was used (part no. TE50FUA, ⅜-inch drive, 0-600 in-lb scale, Snap-on Inc., Kenosha, Wis., USA). The torque wrench was fitted with an appropriately sized ⅜-inch drive socket.

Nut Driver

An air ratchet (Campbell Hausfeld, Harrison, Ohio, USA) was used to drive the nut onto the coated bolt. The air ratchet was driven by house compressed air. The nut driver was fitted with an appropriately sized ⅜-inch socket.

Zahn Cup

A #3 Zahn Type Viscosity Cup (Byk-Gardner, Columbia, Md.) was used to measure adhesive viscosity. A digital stopwatch (VWR Scientific Products, South Plainfield, N.J.) was used to measure the time needed to empty the cup (see Zahn Cup Viscosity Test Method below).

Brookfield Viscometer

Viscosity was measured using a Brookfield LDV-I+ viscometer with cylindrical spindles, L2 and L3. Viscosity readings were taken after the spindle had rotated in the solution for five minutes at room temperature ((20° C.±2° C.).

### TEST METHODS

The following test methods were used to measure physical properties of exemplary uncured and cured adhesive compositions and articles containing the same.

Zahn Cup Viscosity

A #3 Zahn Type Viscosity Cup (Byk-Gardner, Columbia, Md., USA) was used to measure and adjust the adhesive viscosity prior to coating bolts with the adhesive. As described in ASTM Standard D 4212-99, a Zahn cup consists of a bullet-shaped stainless steel cup with an orifice in the bottom. The cup has a 12-inch loop handle to allow the cup to be dipped by hand into a liquid. At the center of this handle is a finger-ring for holding the cup in a vertical position during use. The size of the hole in the bottom of the Zahn cup is selected depending on the viscosity range to be tested. For example, the #3 Zahn cup has an orifice diameter of 0.38 cm and can be used to measure viscosity in the range of 150 to 830 centistokes. In use, the cup is dipped into the liquid whose viscosity is to be measured, such that the cup is filled to the brim. The cup is quickly withdrawn from the liquid, and at the same time, a stopwatch is started to record the time. The stopwatch is stopped when there is a break in the liquid stream coming from the hole in the bottom of the cup. This time is recorded and is indicative of the liquid's viscosity at the measurement temperature (20° C.±2° C.).

Brookfield Viscosity

The sample to be measured was added to an 8 oz. jar (236.6 ml). The 3 L cylindrical spindle was attached to the Brookfield LDV-I+ viscometer and the spindle was inserted into the sample. Viscosity readings were taken 5 minutes after the spindle had rotated in the solution at 100 RPM, (room temperature was 20° C.±2° C.). See ASTM Standard D 2196-99 for more detail.

Initial Breakaway Torque Test

Nuts were applied to five coated bolts using the air-driven nut driver, such that the nut was completely engaged on the coated bolt. The nut-bolt assembly was cured at room temperature (25° C.±2° C.) for 24 hours. After cure, breakaway torque was measured using a follow-up torque wrench (described above). The nut-bolt assembly was held in place in a vise with the nut end up, and the torque wrench with drive socket was fitted over the nut. The needle on the dial of the torque wrench was set to zero, then the nut was loosened with a torque wrench in the counter-clockwise direction. The needle on the dial was deflected to the peak breakaway torque and this value was recorded. The average of five measurements was calculated and converted to N-m units.

Humidity Stability Test

Five coated bolts were placed into a humidity cabinet having a relative humidity of 100% and a temperature of 40° C. The bolts were exposed to the above-described conditions for four hours, such that the bolts were wet from condensed water. The bolts were then removed and cooled to room temperature for twenty four hours. Typically, the bolts were dry at this time. Nuts were then applied to the bolts and the nut-bolt assembly was allowed to cure at room temperature (25° C.±2° C.) for 24 hours. Breakaway torque was measured in the same way as the Initial Breakaway Torque Test described above. The average of five measurements was calculated and converted to N-m units. Breakaway torque values of 5.0 N-m or greater indicated an acceptable degree of humidity resistance.

### EXAMPLES

The following examples were conducted using the materials shown in Table 1 below.

TABLE 1
Materials included in examples

| Trade Designation/Material | Source | Description |
|---|---|---|
| ANQUAMINE ™ 401 | Air Product, Inc., Allentown, | Polyamine polymer |
| | PA | curing agent, 70% solids |
| | | in water |
| ANQUAMINE ™ 701 | Air Product, Inc., Allentown, | Polyamine epoxy resin |
| | PA | adduct emulsion curing |
| | | agent, 55% solids in |
| | | water |
| CORCAT ™ P-600 | EIT Company, | Polyethylenimine polymer, |
| | Lake Wylie, SC | 33% solids in water |
| EPON ™ 815C | Resolution Performance | Epoxy resin |
| | Products, Houston, TX | |
| Epoxy capsules | Custom-made by 3M Canada | Urea-melamine- |
| | Company, London, Ontario, | formaldehyde shell filled |
| | Canada | with EPON ™ 815C epoxy |
| | | resin |
| Formaldehyde solution, (37 wt-%) | Hoechst-Celanese Chemical | Epoxy capsule reactant |
| | Company, Rock Hill, SC | |
| Melamine (Melamine Aero | Cytec Industries, | Epoxy capsule reactant |
| Powder) | Wallingford, CT | |
| 1,3-dipiperidylpropane | Sigma-Aldrich Corp., St. | Epoxy curative in |
| | Louis, MO | SCOTCH-GRIP ™ 2353 |
| | | Fastener Adhesive |
| SCOTCH-GRIP ™ 2353 | 3M Company, St. Paul, MN | Solvent-based fastener |
| Fastener Adhesive | | adhesive |
| Sodium sulfate | IMC Chemicals, Inc., Trona, | Epoxy capsule reactant |
| | CA | |
| Sulfuric acid (6M) | DuPont Chemicals, | Epoxy capsule reactant |
| | Wilmington, DE | |
| Triethanolamine (99%) | Dow Chemical Co., Midland, | Epoxy capsule reactant |
| | MI | |
| Urea (industrial grade, 46% | Arcadian Fertilizer, L. P., | Epoxy capsule reactant |
| nitrogen) | Millington, TN | |

### Example 1

### Preparation of Epoxy Capsules

A urea-melamine-formaldehyde precondensate was prepared by reacting a mixture of 956 g of 37 wt-% formaldehyde solution, 250 g of urea, 110 g of melamine and 8.6 g of triethanolamine for two hours 70° C. The reaction mixture was agitated during the reaction period using a six-blade turbine at 350 RPM, (Note: vessel configuration did not appear to be critical to the formation of the precondensate.) The resulting solution was aged for 18 hours at room temperature and diluted with 2103 g of distilled water to form a prepolymer solution.

1006 g of the prepolymer solution was added to a 4 L stainless steel vessel equipped with baffles and a water jacket for temperature control and fitted with a 2 inch (5.1 cm) diameter, six-bladed turbine agitator 3 inch (7.6 cm) from the bottom of the reactor. The pH of the prepolymer solution was adjusted to 7.0 with 2.2 mL of 6M sulfuric acid and 10.1 g of sodium sulfate at room temperature. The batch temperature was set to 19° C. and agitation was initiated at 700 RPM. 402 g of EPON™ 815C epoxy resin was added, and the agitation speed was increased to 1700 RPM. Stirring continued for 30 minutes to ensure proper emulsification. 6M sulfuric acid was added at a rate of 1 mL per minute, until a pH target of 2.5 was reached, to initiate encapsulation. The reaction conditions were maintained at room temperature for one hour, at which time the temperature was increased to reach a target temperature of 70° C. in 30 minutes and the pH was lowered further to 1.9. The reaction was allowed to proceed over 3.5 hours at which time the mixture was neutralized with 25 wt-% sodium hydroxide (OxyChem, Morristown, N.J.). The slurry was allowed to cool to room temperature overnight, at which point the capsules were filtered and washed (3 times) with 400 mL of warm water (60° C.).

In order to check the bulk stability of the capsules in water, 50 g of capsules were mixed with 50 g of CORCAT™ P-600. The mixture initially had a measured viscosity of 380 cps, which increased only slightly to 470 cps after eight weeks indicating bulk stability of the capsules in water.

### Example 2

### Preparation of Water-Based Adhesive Composition

Three water-based adhesive compositions (Examples 2-1, 2-2, and 2-3) were mixed by weight according to the formulation in Table 2. The mixture was diluted with water so that the viscosity was in the range of 21 to 24 seconds as measured with a #3 Zahn cup.

TABLE 2
Formulation of Examples 2-1 to 2-3

| | Example 2-1 | Example 2-2 | Example 2-3 |
|---|---|---|---|
| Epoxy capsules (g) | 40 | 40 | 40 |
| ANQUAMINE ™ 401 (g) | 30 | | |
| ANQUAMINE ™ 701 (g) | | 30 | |
| CORCAT ™ P-600 (g) | | | 30 |
| Water (g) | 30 | 30 | 30 |

The examples were characterized by measuring viscosity, breakaway torque, and humidity stability. The adhesives were coated on bolts by dipping so that approximately three quarters of the threads were coated. The excess adhesive was removed by scraping the bolt against the container approximately ten times. Five galvanized ⅜ inch bolts were coated for each condition. The bolts were dried in a 70° C. oven for 1 hour and cooled to room temperature. When cooled, galvanized ⅜ inch nuts were applied using an air pressure driven nut driver. The data is included in Table 3.

TABLE 3
Characterization of Examples 2-1 to 2-3

| | Example 2-1 | Example 2-2 | Example 2-3 |
|---|---|---|---|
| Zahn cup #3 | 22 | 23 | 24 |
| viscosity (seconds) | | | |
| Breakaway torque, | 22.8 | 27.4 | 30.9 |
| 24 hr cure (N-m) | | | |
| Humidity stability | 26.4 | 31.5 | 11.4 |
| (N-m) | | | |

### Example 3 and Comparative Example 1

### Film Coating

A mixture of epoxy capsules, polymeric amine, and water were mixed by hand with a tongue depressor until a homogeneous, thick paste was formed. The polymeric amine was ANQUAMINE™ 401 for Example 3-1, ANQUAMINE™ 701 for Example 3-2, and CORCAT™ P-600 for Example 3-3. Comparative Example 1 included a non-polymeric amine (1,3-dipiperidylpropane).

The mixtures were knife-coated between two polyester release liners at a gap of 45 mils (1.13 mm). The samples were heated at 100° C. for 30 minutes. After cooling to room temperature, the top release liner was removed from the sample and an attempt was made to pick up the sample as one piece. The polymeric amine was rated as a positive film formed (i.e., positive) if the sample could be picked up in one piece after heating. The polymeric amine was rated as a negative film (i.e., negative) if the sample could not be picked up in one piece after heating. For example, the film was rated as negative if it crumbled into multiple pieces.

TABLE 4
Film Formation - Examples 3-1 and Comparative Example 1

| | Example | Example | Example | Comp. |
|---|---|---|---|---|
| | 3-1 | 3-2 | 3-3 | Ex. 1 |
| Epoxy capsules (g) | 20 | 20 | 20 | 20 |
| ANQUAMINE ™ | 5 | | | |
| 401 (g) | | | | |
| ANQUAMINE ™ | | 5 | | |
| 701 (g) | | | | |
| CORCAT P-600 (g) | | | 5 | |
| 1,3-dipiperidylpropane | | | | 5 |
| Water (g) | 5 | 5 | 5 | 10 |
| Curative Film | Positive | Positive | Positive | Negative |
| Formation Test | | | | |

While the specification has been described in detail with respect to specific embodiments thereof, it will be appreciated that those skilled in the art, upon attaining an understanding of the foregoing, can readily conceive of alterations to, variations of, and equivalents to these embodiments. Accordingly, the scope of the present invention should be assessed as that of the appended claims and any equivalents thereto.

What is claimed is:

1. An adhesive composition comprising:
a) epoxy capsules comprising an outer shell material and an encapsulated material surrounded by the outer shell material, said encapsulated material comprising an epoxy resin;
b) a polymeric amine that is water soluble or water dispersible, said polymeric amine being a binder and an epoxy curative,
wherein the adhesive composition is substantially free of an additional organic binder material.

2. The adhesive composition of claim 1, wherein the outer shell material comprises a urea-formaldehyde-melamine material.

3. The adhesive composition of claim 1, wherein the epoxy capsules have a median particle size of about 20 to about 120 micrometers.

4. The adhesive composition of claim 1, wherein the epoxy resin comprises a glycidyl ether of polyhydric phenols, said glycidyl ether having at least two epoxy groups per molecule.

5. The adhesive composition of claim 4, wherein the epoxy resin comprises a diglycidyl ether of Bisphenol A.

6. The adhesive composition of claim 4, wherein the encapsulated material further comprises an epoxy diluent.

7. The adhesive composition of claim 1, wherein the epoxy capsules are present in an amount of about 20 to about 60 weight percent and the polymeric amine is present in an amount of about 10 to about 60 weight percent based on the weight of the adhesive composition.

8. The adhesive composition of claim 1, further comprising an inorganic or polymeric filler material.

9. The adhesive composition of claim 1, wherein the polymeric amine comprises a polyamidoamine, a polyethylenimine, a polyoxyalkyleneamines, or a combination thereof.

10. The adhesive composition of claim 1, wherein the adhesive composition comprises a first part and a second part, wherein the first part comprise the epoxy capsules and the second part comprises the polymeric amine.

11. An article comprising:
a) a substrate having an outer surface; and
b) a water-based adhesive composition on at least a portion of the outer surface of the substrate, said adhesive composition comprising:
i) epoxy capsules comprising an outer shell material and an encapsulated material surrounded by the outer shell material, said encapsulated material comprising an epoxy resin;
ii) a polymeric amine that is water soluble or water dispersible, said polymeric amine being a binder and an epoxy curative,
wherein the adhesive composition is substantially free of an additional organic binder resin.

12. The article of claim 11, wherein the substrate is a three-dimensional shape, a film, a foil, a fabric, a tube, a pipe, or a mechanical fastener.

13. The article of claim 12, wherein the substrate is a mechanical fastener.

14. The article of claim 13, wherein the mechanical fastener comprises a screw, bolt, pipe joint, nut, nail, or a bolt/nut assembly.

15. The article of claim 13, wherein the mechanical fastener comprises a bolt, and wherein the bolt having the reaction product of the adhesive composition thereof and a subsequently attached nut exhibit a breakaway torque value greater than about 5 N-m following a Humidity Resistance Test.

16. The article of claim 15, wherein the breakaway torque value is greater than about 10 N-m following a Humidity Resistance Test.

17. The article of claim 11, wherein the epoxy capsules are present in an amount of about 20 to about 60 weight percent and the polymeric amine is present in an amount of about 10 to about 60 weight percent based on the weight of the adhesive composition.

18. The article of claim 11, wherein the adhesive composition further comprises an inorganic or polymeric filler.

19. The article of claim 11, wherein the adhesive composition further comprises a thickener.

20. A method of making an article comprising applying a water-based substrate to at least a portion of an outer surface of a substrate, said adhesive composition comprising:
a) epoxy capsules comprising an outer shell material and an encapsulated material within the outer shell material, said encapsulated material comprising an epoxy resin;
b) a polymeric amine that is water soluble or water dispersible, said polymeric amine being a binder and an epoxy curative,
wherein the adhesive composition is substantially free of an additional organic binder resin.
